(19) United States
(12) Patent Application Publication
(10) Pub. No.: US 2017/0195004 A1
(43) Pub. Date: Jul. 6, 2017

(54) Antenna apparatus applied to mobile terminal and mobile terminal

(71) Applicants: Le Holdings (Beijing) Co., Ltd., Beijing (CN); Lemobile Information Technology (Beijing) Co., Ltd., Beijing (CN)

(72) Inventors: Bo CHENG, Beijing (CN); Huanqu HUANG, Beijing (CN)

(21) Appl. No.: 15/241,806

(22) Filed: Aug. 19, 2016

Related U.S. Application Data
(63) Continuation of application No. PCT/CN2016/088824, filed on Jul. 6, 2016.

(30) Foreign Application Priority Data
Jan. 6, 2016 (CN) 2016100095833

(51) Int. Cl. H04B 1/58; H04B 7/04

(52) U.S. Cl. CPC H04B 1/58; H04B 7/04; H04W 88/02

(57) ABSTRACT

Disclosed is an antenna device applied to a mobile terminal and mobile terminal. An antenna device applied to a mobile terminal comprises: a plurality of wide-frequency antennas, a plurality of switch arrays in the same number as the wide-frequency antennas, and a controller; the wide-frequency antennas are respectively disposed at different positions of the mobile terminal, each switch array among the switch arrays is connected with a different wide-frequency antenna among the wide-frequency antennas, the switch arrays are respectively connected with the controller; the controller is configured to determine an antenna among the four wide-frequency antennas which is available for a preset use scenario when the mobile terminal is in the preset use scenario; the switch array is configured to, according to control of the controller, turn on the antenna available for the preset use scenario among the wide-frequency antennas connected to the switch array with a radio frequency module.

### CROSS REFERENCE TO RELATED DISCLOSURES

The present application is a continuation of PCT application which has an application number of PCT/CN2016/088824 and was filed on Jul. 6, 2016. This disclosure is based upon and claims priority to Chinese Patent Disclosure NO. 201610009583.3, titled “antenna device applied to mobile terminal and mobile terminal”, filed on Jan. 6, 2016 with the Chinese Patent Office, the entire contents of which are incorporated herein by reference.

### TECHNICAL FIELD

The disclosure relates to the technical field of antennas, and more specifically to an antenna device applied to a mobile terminal and mobile terminal.

### BACKGROUND

As wireless communication technology develops increasingly, antenna design has become one of bottlenecks of a mobile terminal such as a mobile phone for the following reasons: the mobile terminal supports a diversity of wireless technologies; besides mobile cellular communication, the mobile terminal further needs to support wireless technologies such as WiFi, GPS, WiHD and NFC, and the number of antennas increases therewith. Hence, how to add antennas into the mobile terminal having a smaller volume becomes a difficult issue of antenna arrangement; on the other hand, a human body (particularly head and hand) exerts a great influence on antenna performance. Take a mobile phone as an example. When the user holds the mobile phone or his head approaches the mobile phone, an influence is applied to the antenna performance. Mainstream mobile terminal manufacturers all list antenna performance under influence of head and hand as a major performance index of the mobile terminal. Hence, how to ensure performance of respective antennas under various use scenarios becomes another difficult issue of antenna arrangement.

In the relevant prior art, antennas all employ a relatively fixed arrangement form. Take a mobile phone as an example. A primary antenna of the mobile phone is located in a lower portion of the mobile phone, a diversity antenna and WiFi/GPS antenna are located in an upper portion of the mobile phone (respectively located at a left upper corner and a right upper corner of the mobile phone), and such antenna arrangement almost becomes a practice in the industry.

Although this arrangement manner may ensure the performance of respective antennas in a free space, antenna performance is still confronted with deterioration to a different extent under various application scenarios, e.g., various hand-held modes (including transverse holding and vertical holding) or call-answering mode, and affects the user's user experience.

### SUMMARY

An object of the present application is to provide an antenna device applied to a mobile terminal and a mobile terminal.

According to an aspect of the present disclosure, there is provided an antenna device applied to a mobile terminal, comprising: a plurality of wide-frequency antennas, a plurality of switch arrays in the same number as the wide-frequency antennas, and a controller; wherein the plurality of wide-frequency antennas are respectively disposed at different positions of the mobile terminal, each switch array among the plurality of switch arrays is connected with a different wide-frequency antenna among the plurality of wide-frequency antennas, the plurality of switch arrays are respectively connected with the controller, and the wide-frequency antenna comprises antennas at a plurality of frequency bands; the controller is configured to determine an antenna among the four wide-frequency antennas which is available for a preset use scenario, when the mobile terminal is in the preset use scenario, the antenna available for the preset use scenario being capable of satisfying a preset antenna performance under the preset use scenario; the switch array is configured to, according to control of the controller, turn on the antenna available for the preset use scenario among the wide-frequency antennas connected to the switch array with a radio frequency module.

Optionally, the plurality of wide-frequency antennas are four wide-frequency antennas, and the plurality of switch arrays are four switch arrays.

Optionally, the four wide-frequency antennas are disposed at four corners of the mobile terminal.

Optionally, the preset use scenario comprises holding a mobile terminal and making a call.

Optionally, the switch array consists of a 4P4T switch, or consists of a 3P3T switch and a radio frequency switch, or consists of two DPDT switches.

Optionally, the wide-frequency antennas comprise at least two of a mobile cellular communication antenna, a WiFi antenna, a GPS antenna, a WiHD antenna and a NFC antenna.

Optionally, the mobile cellular communication antenna comprises a primary antenna and a diversity antenna.

Optionally, when the plurality of antennas are four wide-frequency antennas and the plurality of switch arrays are four switch arrays, the four switch arrays respectively are: a first switch array connected with the wide-frequency antenna arranged at a left upper corner of the mobile terminal, a second switch array connected with the wide-frequency antenna arranged at a right upper corner of the mobile terminal, a third switch array connected with the wide-frequency antenna arranged at a left lower corner of the mobile terminal and a fourth switch array connected with the wide-frequency antenna arranged at a right lower corner of the mobile terminal; the controller is further configured to, when the mobile terminal is not in the preset use scenario, control the first switch array to turn on a diversity antenna in the wide-frequency antenna connected to the first switch array with the radio frequency module, control the second switch array to turn on a WiFi antenna and/or GPS antenna in the wide-frequency antenna connected to the second switch array with the radio frequency module, and control the third switch array or fourth switch array to turn on a primary antenna in the wide-frequency antenna connected to the third switch array with the radio frequency module.

According to another aspect of the present disclosure, there is provided a mobile terminal, comprising the above-mentioned antenna device and a sensor module; wherein the sensor module is configured to detect whether the mobile terminal is in a preset use scenario.

In the antenna device applied to the mobile terminal and the mobile antenna according to the present embodiment, the performance of the antenna is ensured by detecting whether there is shielding with sensors disposed adjacent to the plurality wide-frequency antennas and by selecting the antenna available for the preset use scenario according to the intensity of the signal.

### BRIEF DESCRIPTION OF THE DRAWINGS

One or more embodiments is/are accompanied by the following figures for illustrative purposes and serve to only to provide examples. These illustrative descriptions in no way limit any embodiments. Similar elements in the figures are denoted by identical reference numbers. Unless it states the otherwise, it should be understood that the drawings are not necessarily proportional or to scale.

FIG. 1 is a schematic view of arrangement of a plurality of wide-frequency antennas according to the present disclosure;

FIG. 2 is a structural schematic view of circuit logic of an antenna device applied to a mobile terminal according to an embodiment of the present disclosure;

FIG. 3 is a structural schematic view of circuit logic of an antenna device applied to a mobile terminal according to an embodiment of the present disclosure;

FIG. 4 is a structural schematic view of circuit logic of an antenna device applied to a mobile terminal according to an embodiment of the present disclosure.

### DETAILED DESCRIPTION

Exemplary embodiments of the present disclosure will be described in more detail below with reference to figures. Although the figures show exemplary embodiments of the present disclosure, it should be appreciated that the present disclosure may be implemented in various forms and should not be limited by embodiments illustrated here. On the contrary, these embodiments are provided to enable more thorough understanding of the present disclosure, and completely convey the scope of the present disclosure to those skilled in the art.

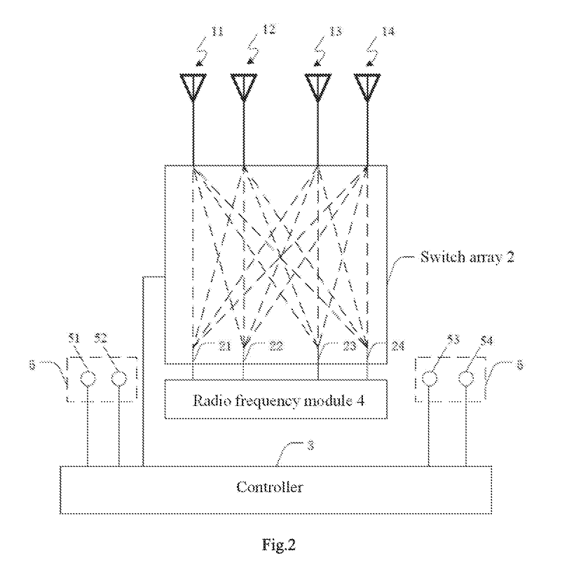

In an embodiment of an antenna device applied to a mobile terminal according to the present disclosure, as shown in FIG. 2, the antenna device 100 comprising: a plurality of wide-frequency antennas 1, a plurality of switch arrays 2 in the same number as the wide-frequency antennas, and a controller 3.

Wherein the plurality of wide-frequency antennas 1 are respectively disposed at different positions of the mobile terminal, each switch array among the plurality of switch arrays 2 is connected with a different wide-frequency antenna among the plurality of wide-frequency antennas 1, the plurality of switch arrays 2 are respectively connected with the controller 3, and the wide-frequency antenna 1 comprises antennas at a plurality of frequency bands. The wide-frequency antennas comprise at least two of a mobile cellular communication antenna, a WiFi antenna, a GPS antenna, a WiHD antenna and a NFC antenna.

In the present embodiment, the plurality of wide-frequency antennas comprise a first wide-frequency antenna 11, a second wide-frequency antenna 12, a third wide-frequency antenna 13 and a fourth wide-frequency antenna 14, wherein the first wide-frequency antenna 11 may be a mobile cellular communication antenna, the second wide-frequency antenna may be a WiFi antenna, the third wide-frequency antenna may be a GPS antenna, and the fourth wide-frequency antenna may be a WiHD antenna.

Correspondingly, the plurality of switch arrays 2 comprise a first switch array 21, a second switch array 22, a third switch array 23 and a fourth switch array 24.

In the present embodiment, the switch array 2 is consists of one 4P4T switch, the first switch array 21 is connected with the first through fourth wide-frequency antennas (11-14) respectively, the second switch array 22 is connected with the first through fourth wide-frequency antennas (11-14) respectively, the third switch array 23 is connected with the first through fourth wide-frequency antennas (11-14) respectively, and the fourth switch array 24 is connected with the first through fourth wide-frequency antennas (11-14) respectively.

The controller 3 is configured to determine an antenna among the four wide-frequency antennas which is available for a preset use scenario when the mobile terminal is in the preset use scenario. The antenna available for the preset use scenario being capable of satisfying a preset antenna performance under the preset use scenario.

In the present embodiment, the preset use scenario comprises holding a mobile terminal and making a call. Upon holding the mobile terminal or making a call, the controller 3 determines an antenna for the scenario of holding a mobile terminal or making a call, whereupon the antenna performance is better.

The switch array is configured to, according to control of the controller, turn on an antenna available for the preset use scenario among the wide-frequency antennas connected to the switch array with a radio frequency module.

In the present embodiment, the switch array 2, according to the control of the controller 3, turn on an antenna determined available for the scenario of holding a mobile terminal or making a call among the wide-frequency antennas connected therewith, with a radio frequency module 4.

In the present embodiment, the switch array 2 may be a switch array consists of a switch diode, a switch array consists of a micro wave switch, a switch array consists of a relay, or the like.

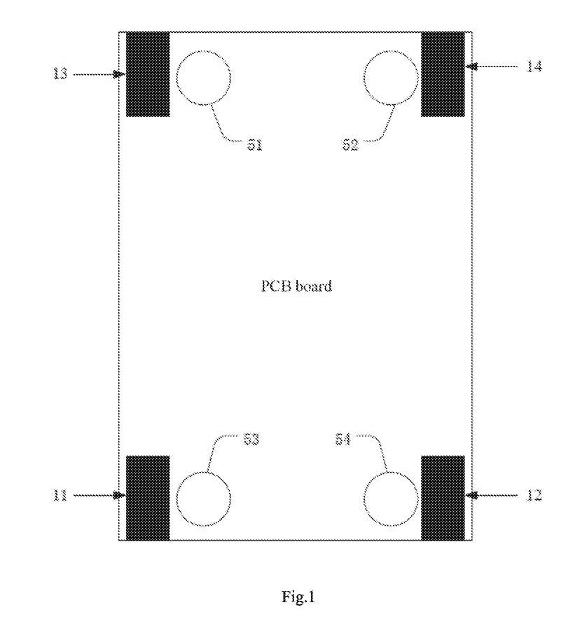

In the present embodiment, as shown in FIG. 1, the first through fourth wide-frequency antennas are respectively disposed at four corners of the mobile terminal, wherein the first wide-frequency antenna 11 is located at a left lower corner of the mobile terminal, the second wide-frequency antenna 12 is located at a right lower corner of the mobile terminal, the third wide-frequency antenna 13 is located at a left upper corner of the mobile terminal, and the fourth wide-frequency antenna 14 is located at a right upper corner of the mobile terminal.

In the antenna device applied to the mobile terminal according to the present embodiment, the performance of the antenna is ensured by detecting whether there is shielding with sensors disposed adjacent to the plurality wide-frequency antennas and by selecting the antenna available for the preset use scenario according to the intensity of the signal.

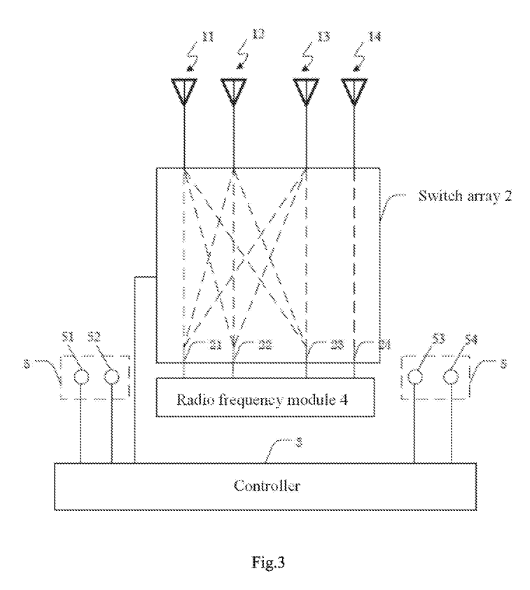

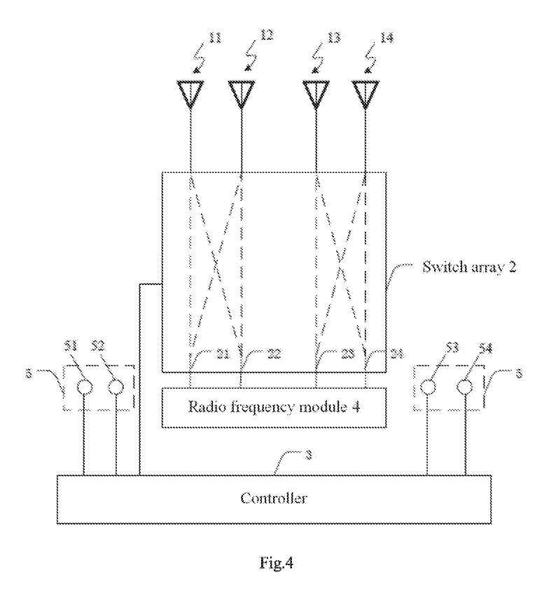

FIG. 3 is a structural schematic view of circuit logic of an antenna device applied to a mobile terminal according to an embodiment of the present disclosure. This embodiment differs from the previous embodiment in that the switch array consists of a 3P3T switch and a radio frequency switch. Other aspects of the present embodiment are all consistent with those in the previous embodiment and will not be detailed here. If the switch array 2 consists of a 3P3T switch and a radio frequency switch, the first switch array 21 is connected with the first through third wide-frequency antennas (11-13) respectively, the second switch array 22 is connected with the first through third wide-frequency antennas (11-13) respectively, the third switch array 23 is connected with the first through third wide-frequency antennas (11-13) respectively, and the fourth switch array 24 is connected with the fourth wide-frequency antenna 14. FIG. 4 is a structural schematic view of circuit logic of an antenna device applied to a mobile terminal according to an embodiment of the present disclosure. This embodiment differs from the previous embodiment in that the switch array consists of two DPDT switches. Other aspects of the present embodiment are all consistent with those in the previous embodiment and will not be detailed here.

If the switch array 2 consists of two DPDT switches, the first switch array 21 is connected with the first wide-frequency antenna 11 and the second wide-frequency antenna 12 respectively, the second switch array 22 is connected with the first wide-frequency antenna 11 and the second wide-frequency antenna 12 respectively, the third switch array 23 is connected with the third wide-frequency antenna 13 and the fourth wide-frequency antenna 14 respectively, and the fourth switch array 24 is connected with the third wide-frequency antenna 13 and the fourth wide-frequency antenna 14 respectively.

As shown in FIG. 2-FIG. 4, the present embodiment further provides a mobile terminal, comprising the above-mentioned antenna device and a sensor module 5; the sensor module 5 is configured to detect whether the mobile terminal is in a preset use scenario. The mobile terminal may be mobile phone, but the present application should not be limited to this. The mobile terminal may further be a flat panel computer or other communication devices on which the antenna needs to be amounted.

The sensor module 5 comprises a first distance sensor 51, a second distance sensor 52, a third distance sensor 53 and a fourth distance sensor 54, wherein the first distance sensor 51 is adjacent to the first wide-frequency antenna 11, the second distance sensor 52 is adjacent to the second wide-frequency antenna 12, the third distance sensor 53 is adjacent to the third wide-frequency antenna 13, and the fourth distance sensor 54 is adjacent to the fourth wide-frequency antenna 14.

Wherein the first distance sensor 51 is configured to detect whether there is an object or person whose distance from the first wide-frequency antenna 11 is within a preset range, and to output a first detection signal.

The second distance sensor 52 is configured to detect whether there is an object or person whose distance from the second wide-frequency antenna 12 is within a preset range, and to output a second detection signal.

The third distance sensor 53 is configured to detect whether there is an object or person whose distance from the third wide-frequency antenna 13 is within a preset range, and to output a third detection signal.

The fourth distance sensor 54 is configured to detect whether there is an object or person whose distance from the fourth wide-frequency antenna 14 is within a preset range, and to output a fourth detection signal.

In the present embodiment, since the first through fourth distance sensors (51-54) are configured to detect influence on the antenna performance when an antenna main body is exerted by holding a mobile phone by a hand or holding a mobile phone and putting it close to the user's face, the first distance sensor 51 is disposed adjacent to the first wide-frequency antenna 11, the second distance sensor 52 is disposed adjacent to the second wide-frequency antenna 12, the third distance sensor 53 is disposed adjacent to the third wide-frequency antenna 13, and the fourth distance sensor 54 is disposed adjacent to the fourth wide-frequency antenna 14. This ensures that when the first through fourth wide-frequency antennas (11-14) are shielded or not shielded, the first through fourth distance sensors (51-54) are synchronously shielded or not shielded.

In the present embodiment, when there is an object or person whose distance from the first through fourth wide-frequency antennas (11-14) is in a preset range, an amplitude value of a sensing signal obtained by the first through fourth distance sensors (51-54) is greater than or equal to a preset threshold, and a signal indicating that the first through fourth wide-frequency antennas (11-14) are detected as being shielded is transmitted from the first through fourth distance sensors (51-54) to the controller 3; when there is not an object or person whose distance from the first through fourth wide-frequency antennas (11-14) is in a preset range, an amplitude value of a sensing signal obtained by the first through fourth distance sensors (51-54) is smaller than a preset threshold, and a signal indicating that the first through fourth wide-frequency antennas (11-14) are detected as not being shielded is transmitted from the first through fourth distance sensors (51-54) to the controller 3.

The controller 3 is further configured to, according to an intensity of the signal, control the switch array 2 to select a wide-frequency antenna with a strong signal, and allow it to turn on with the radio frequency module 4.

In an optional embodiment, the first wide-frequency antenna 11 and second wide-frequency antenna 12 are cellular communication antennas and used as primary antennas to transmit and receive a signal, the third wide-frequency antenna 13 is a cellular communication antenna and used use a diversity antenna to transmit and receive a signal, and the fourth wide-frequency antenna 3 is a WiFi antenna and used as a WiFi antenna to transmit and receive a signal.

When the distance sensor fails to detect a hand, it outputs a high level; when the distance sensor detects a hand, it outputs a low level; the distance sensor reports a detection result to the controller, and the controller controls the switch array through a preset logic to achieve an object of controlling the antenna.

What are described above are only preferred embodiments of the present disclosure, and not intended to limit the present disclosure. Those skilled in the art appreciate that the present disclosure may have various modifications and variations. Any modifications, equivalent substitutes and improvements within the spirit and principles of the present disclosure all fall within the protection scope of the present invention.

1-9. (canceled)

10. An antenna device applied to a mobile terminal, comprising: a plurality of wide-frequency antennas, a plurality of switch arrays in the same number as the wide-frequency antennas, and a controller; wherein the plurality of wide-frequency antennas are respectively disposed at different positions of the mobile terminal, each switch array among the plurality of switch arrays is connected with a different wide-frequency antenna among the plurality of wide-frequency antennas, the plurality of switch arrays are respectively connected with the controller, and the wide-frequency antenna comprises antennas at a plurality of frequency bands;
the controller is configured to determine an antenna among the four wide-frequency antennas which is available for a preset use scenario, when the mobile terminal is in the preset use scenario, the antenna available for the preset use scenario being capable of satisfying a preset antenna performance under the preset use scenario;
the switch array is configured to, according to control of the controller, turn on the antenna available for the preset use scenario among the wide-frequency antennas connected to the switch array with a radio frequency module.

11. The antenna device according to claim 10, wherein the plurality of wide-frequency antennas are four wide-frequency antennas, and the plurality of switch arrays are four switch arrays.

12. The antenna device according to claim 11, wherein the four wide-frequency antennas are disposed at four corners of the mobile terminal.

13. The antenna device according to claim 10, wherein the preset use scenario comprises holding a mobile terminal and making a call.

14. The antenna device according to claim 10, wherein the switch array consists of a 4P4T switch, or consists of a 3P3T switch and a radio frequency switch, or consists of two DPDT switches.

15. The antenna device according to claim 10, wherein the wide-frequency antennas comprise at least two of a mobile cellular communication antenna, a WiFi antenna, a GPS antenna, a WiHD antenna or a NFC antenna.

16. The antenna device according to claim 15, wherein the mobile cellular communication antenna comprises a primary antenna and a diversity antenna.

17. The antenna device according to claim 16, wherein when the plurality of antennas are four wide-frequency antennas and the plurality of switch arrays are four switch arrays, the four switch arrays respectively are: a first switch array connected with the wide-frequency antenna arranged at a left upper corner of the mobile terminal, a second switch array connected with the wide-frequency antenna arranged at a right upper corner of the mobile terminal, a third switch array connected with the wide-frequency antenna arranged at a left lower corner of the mobile terminal and a fourth switch array connected with the wide-frequency antenna arranged at a right lower corner of the mobile terminal;
the controller is further configured to, when the mobile terminal is not in the preset use scenario, control the first switch array to turn on a diversity antenna in the wide-frequency antenna connected to the first switch array with the radio frequency module, control the second switch array to turn on a WiFi antenna and/or GPS antenna in the wide-frequency antenna connected to the second switch array with the radio frequency module, and control the third switch array or fourth switch array to turn on a primary antenna in the wide-frequency antenna connected to the third switch array with the radio frequency module.

18. A mobile terminal, comprising the antenna device and a sensor module:
Wherein the antenna device comprises: a plurality of wide-frequency antennas, a plurality of switch arrays in the same number as the wide-frequency antennas, and a controller; wherein the plurality of wide-frequency antennas are respectively disposed at different positions of the mobile terminal, each switch array among the plurality of switch arrays is connected with a different wide-frequency antenna among the plurality of wide-frequency antennas, the plurality of switch arrays are respectively connected with the controller, and the wide-frequency antenna comprises antennas at a plurality of frequency bands;
the controller is configured to determine an antenna among the four wide-frequency antennas which is available for a preset use scenario, when the mobile terminal is in the preset use scenario, the antenna available for the preset use scenario being capable of satisfying a preset antenna performance under the preset use scenario;
the switch array is configured to, according to control of the controller, turn on the antenna available for the preset use scenario among the wide-frequency antennas connected to the switch array with a radio frequency module.
wherein the sensor module is configured to detect whether the mobile terminal is in a preset use scenario.

19. The mobile terminal according to claim 18, wherein the plurality of wide-frequency antennas are four wide-frequency antennas, and the plurality of switch arrays are four switch arrays.

20. The mobile terminal according to claim 19, wherein the four wide-frequency antennas are disposed at four corners of the mobile terminal.

21. The mobile terminal according to claim 18, wherein the preset use scenario comprises holding a mobile terminal and making a call.

22. The mobile terminal according to claim 18, wherein the switch array consists of a 4P4T switch, or consists of a 3P3T switch and a radio frequency switch, or consists of two DPDT switches.

23. The mobile terminal according to claim 18, wherein the wide-frequency antennas comprise at least two of a mobile cellular communication antenna, a WiFi antenna, a GPS antenna, a WiHD antenna or a NFC antenna.

24. The mobile terminal according to claim 23, wherein the mobile cellular communication antenna comprises a primary antenna and a diversity antenna.

25. The mobile terminal according to claim 24, wherein when the plurality of antennas are four wide-frequency antennas and the plurality of switch arrays are four switch arrays, the four switch arrays respectively are: a first switch array connected with the wide-frequency antenna arranged at a left upper corner of the mobile terminal, a second switch array connected with the wide-frequency antenna arranged at a right upper corner of the mobile terminal, a third switch array connected with the wide-frequency antenna arranged at a left lower corner of the mobile terminal and a fourth switch array connected with the wide-frequency antenna arranged at a right lower corner of the mobile terminal;
the controller is further configured to, when the mobile terminal is not in the preset use scenario, control the first switch array to turn on a diversity antenna in the wide-frequency antenna connected to the first switch array with the radio frequency module, control the second switch array to turn on a WiFi antenna and/or GPS antenna in the wide-frequency antenna connected to the second switch array with the radio frequency module, and control the third switch array or fourth switch array to turn on a primary antenna in the wide-frequency antenna connected to the third switch array with the radio frequency module.
